(19) United States
(12) Patent Application Publication
(10) Pub. No.: US 2026/0010561 A1
(43) Pub. Date: Jan. 8, 2026

(54) CLUSTERING TERMS USING MACHINE LEARNING MODELS

(71) Applicant: Modernvivo Inc., Ann Arbor, MI (US)

(72) Inventors: Colin Robert Small, Seattle, WA (US); Ryan Yuki Huang, Rancho Cordova, CA (US)

(21) Appl. No.: 18/952,884

(22) Filed: Nov. 19, 2024

Related U.S. Application Data
(60) Provisional application No. 63/667,447, filed on Jul. 3, 2024.

(51) Int. Cl. G06F 16/35

(52) U.S. Cl. CPC G06F 16/353

(57) ABSTRACT

Methods, systems, and apparatus, including computer programs encoded on computer storage media, for clustering terms. One of the methods includes obtaining a plurality of text sequences to be clustered; obtaining a context text sequence specifying a context for the clustering; for each text sequence of the plurality of text sequences, processing the text sequence and the context text sequence using a language model neural network to generate a respective extracted term that describes content from the text sequence that is relevant to the context; and clustering the respective extracted terms for the text sequences into a plurality of clusters.

### CROSS-REFERENCE TO RELATED APPLICATION

This application claims priority to U.S. Provisional Application No. 63/667,447, filed on Jul. 3, 2024. The disclosure of the prior application is considered part of and is incorporated by reference in the disclosure of this application.

### BACKGROUND

This specification relates to clustering terms using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that clusters terms using a language model neural network.

According to one aspect there is provided a computer-implemented method comprising: obtaining a plurality of text sequences to be clustered; obtaining a context text sequence specifying a context for the clustering; for each text sequence of the plurality of text sequences, processing the text sequence and the context text sequence using a language model neural network to generate a respective extracted term that describes content from the text sequence that is relevant to the context; and clustering the respective extracted terms for the text sequences into a plurality of clusters.

In some implementations, the method further comprises: for each cluster, and for each respective extracted term in the cluster, associating with the cluster the text sequence for which the respective extracted term was generated.

In some implementations, obtaining the context text sequence comprises receiving the context text sequence from a user.

In some implementations, obtaining a plurality of text sequences to be clustered comprises receiving the plurality of text sequences from a user.

In some implementations, processing the text sequence and the context text sequence using a language model neural network to generate a respective extracted term comprises providing a prompt comprising the text sequence and the context text sequence as input to the language model neural network.

In some implementations, the prompt further comprises an instruction to extract information from the text sequence that is relevant to the context text sequence.

In some implementations, the prompt further comprises one or more examples, wherein each example comprises an example text sequence and one or more example extracted terms that describe content from the example text sequence that is relevant to the context, and wherein the prompt further comprises an instruction to extract information from the text sequence that is relevant to the context according to the examples.

In some implementations, clustering the respective extracted terms for the text sequences into a plurality of clusters comprises: initializing a set of one or more clusters to include at least a first cluster; and for each of one or more of the respective extracted terms: processing each of one or more clusters of the set of clusters, comprising: providing a comparison input prompt comprising i) the respective extracted term, ii) a respective label for the cluster, and iii) the context text sequence as input to a second language model neural network to generate an output specifying whether the respective extracted term and the respective label are semantically equivalent given the context sequence; determining whether the respective extracted term and the respective label are semantically equivalent based on the output; and in response to determining that the respective extracted term and the respective label are semantically equivalent, assigning the respective extracted term to the cluster.

In some implementations, the respective label for the cluster comprises a first respective extracted term assigned to the cluster.

In some implementations, initializing a set of one or more clusters to include at least a first cluster comprises: providing an initial comparison input prompt comprising i) a first term of the respective extracted terms, ii) a second term of the respective extracted terms, and iii) the context text sequence as input to the second language model neural network to generate an initial output specifying whether the first term and the second term are semantically equivalent given the context sequence; determining whether the first term and the second term are semantically equivalent based on the initial output; and in response to determining that the first term and the second term are semantically equivalent, assigning the first term and the second term to the first cluster.

In some implementations, the method further comprises, in response to determining that the first term and the second term are not semantically equivalent: assigning the first term to the first cluster; updating the set of clusters to include a second cluster; and assigning the second term to the second cluster.

In some implementations, processing each of one or more of clusters of the set of clusters comprises processing each of the one or more clusters according to an order for the set of clusters, and wherein the method further comprises, for each of one or more of the respective extracted terms, identifying the order for the set of clusters for the respective extracted term.

In some implementations, identifying the order for the set of clusters for the respective extracted term comprises: generating, for each cluster in the set of clusters, an embedding similarity score for the respective label for the cluster and the respective extracted term; and ordering the clusters in the set of clusters based on the embedding similarity scores.

In some implementations, generating, for each cluster in the set of clusters, an embedding similarity score for the respective label for the cluster and the respective extracted term comprises: generating an extracted term embedding for the respective extracted term; and generating, for each cluster, the embedding similarity score based on a distance between an embedding for the respective label and the extracted term embedding.

In some implementations, the method further comprises, for each of one or more of the respective extracted terms: determining that the respective extracted term is not assigned to any of the one or more clusters; in response, updating the set to include a new cluster; and assigning the respective extracted term to the new cluster.

In some implementations, one or more of the text sequences describes a laboratory procedure, and wherein the context text sequence specifies an aspect of the laboratory procedure.

According to another aspect there is provided one or more non-transitory computer storage media storing instructions that when executed by one or more computers cause the one or more computer to perform the respective operations of the methods described herein.

According to another aspect there is provided a system comprising: one or more computers; and one or more storage devices storing instructions that, when executed by the one or more computers, cause the one or more computers to perform the respective operations of the methods described herein.

Other embodiments of this aspect include corresponding computer systems, apparatus, and computer programs recorded on one or more computer storage devices, each configured to perform the actions of the methods.

Particular embodiments of the subject matter described in this specification can be implemented so as to realize one or more of the following advantages.

The system described in this specification performs text clustering, allowing for various downstream applications such as organizing and extracting information from collections of textual data, and building recommendation systems. However, in some examples, textual data is unstructured, highly specialized or noisy. Some conventional systems do not perform well given unstructured text sequences, or given esoteric terms being present in the text sequences that need to be clustered. For example, some conventional systems cluster text sequences based on representations of the text sequences in an embedding space, rather than the meaning of terms within the text sequences. In addition, some conventional systems do not perform clustering according to a specific context for the text sequences, leading to unfocused clusters. As another example, multiple terms within the text sequences can have the same meaning. Some conventional systems do not fully discern similarities in texts that require understanding of nuanced or domain-specific meanings, resulting in inaccurate clusters.

The system described in this specification clusters a collection of text sequences given a context by which the text sequences should be grouped. For example, the system uses a language model neural network to extract terms from the text sequences that are relevant to the context. The system then assigns terms to clusters based on whether the terms are semantically equivalent to each other based on the context. Thus, the system described in this specification clusters text sequences based on the underlying meaning of the text based on the context, removing the noise of the textual data and ensuring that relevant information is extracted for clustering. Furthermore, by using a language model neural network to extract and assign terms to clusters according to a given context, the system can generate accurate clusters for highly specialized domains.

Some conventional systems can be trained to cluster terms for a particular domain. However, training these systems requires a large amount of labeled training data. The system described in this specification can cluster terms for a variety of domains without having been trained for those domains. For example, the system can extract terms relevant to a new context, and assign the extracted terms based on the new context, without needing to be re-trained for the new context.

In addition, some conventional systems for clustering text may require a user to submit inputs specifying hyperparameters of the clustering, e.g., the number of clusters that should be generated. The system described in this specification automates the clustering. For example, when assigning terms to clusters, the system can determine to include a new cluster for a particular extracted term based on whether the extracted term is semantically equivalent to any of the labels of the existing clusters. Thus the system described in this specification provides for a flexible and automated user experience.

Moreover, the system described in this specification can perform text clustering in a computationally efficient manner. For example, the system can assign an extracted term to a cluster by comparing the extracted term with labels of the existing clusters using a language model neural network. Making a large number of calls to a language model neural network can be computationally expensive, e.g., performing inference using the language model neural network many times can require large amounts of computing time and resources. Rather than making a separate call to a language model neural network to perform a comparison for the extracted term and each extracted term in each existing cluster, which can require a large number of calls as the number of terms in each cluster increases, the system described in this specification can compare the extracted term with a single label for each existing cluster. The system can thus make a single call for the extracted term and each cluster, reducing the number of calls to the language model neural network. In addition, the system can perform the comparisons for the extracted term in a particular order for the extracted term. Rather than calling the language model neural network to perform comparisons for the extracted term and a label for each existing cluster in a random order or predetermined order that is the same for each extracted term, which can require a large number of calls as the number of clusters increases, the system can perform the comparisons in order of descending embedding similarity between the extracted term and the labels of the existing clusters. Performing the comparisons in the order increases the likelihood that the extracted term will be assigned to a cluster earlier in the order, and reduces the likelihood that the system will need to call the language model neural network to perform comparisons for a large proportion or all of the clusters. The system can thus reduce the number of calls to the language model neural network.

In addition, the system described in this specification can perform text clustering in a flexible manner. For example, the system can use any appropriate language model neural network to generate extracted terms, and any appropriate language model neural network to assign extracted terms to clusters. In some examples, the system can use a smaller language model neural network, e.g., having a smaller number of parameters than a larger language model neural network, for less complex clustering tasks or domains, and a larger language model neural network, e.g., having a greater number of parameters than the smaller language model neural network, for more complex clustering tasks or domains. In some examples, the system can use a language model neural network that has been trained or further trained to generate extracted terms or to assign extracted terms to clusters for a particular domain.

In some examples, the system can use the same language model neural network to generate extracted terms and to assign extracted terms to clusters. The system can reduce the amount of computing resources required to maintain and perform inference compared to using multiple language model neural networks. In some examples, the system can use different language model neural networks to generate extracted terms and to assign extracted terms to clusters. For example, the system can use a smaller language model neural network to assign extracted terms than the language model neural network used to generate extracted terms. The system can thus reduce the number of calls to a larger language model neural network that requires more computing resources to maintain and to perform inference.

Furthermore, training a language model neural network is computationally expensive. In the system described in this specification, the same language model neural network can be used to perform context-specific clustering for multiple different contexts, or for multiple sets of text sequences that need to be clustered, or both, without needing to be re-trained. Thus the system can perform text clustering for different contexts or sets of text sequences in a computationally efficient manner.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example clustering system.

FIGS. 2A-2B show an example process for clustering terms.

FIG. 3 is a flow diagram of an example process for clustering terms.

FIG. 4 is a flow diagram of an example process for assigning terms to clusters.

FIG. 5 is a flow diagram of an example process for initializing a set of clusters.

FIG. 6 shows the performance of an example clustering system.

Like reference numbers and designations in the various drawings indicate like elements.

### DETAILED DESCRIPTION

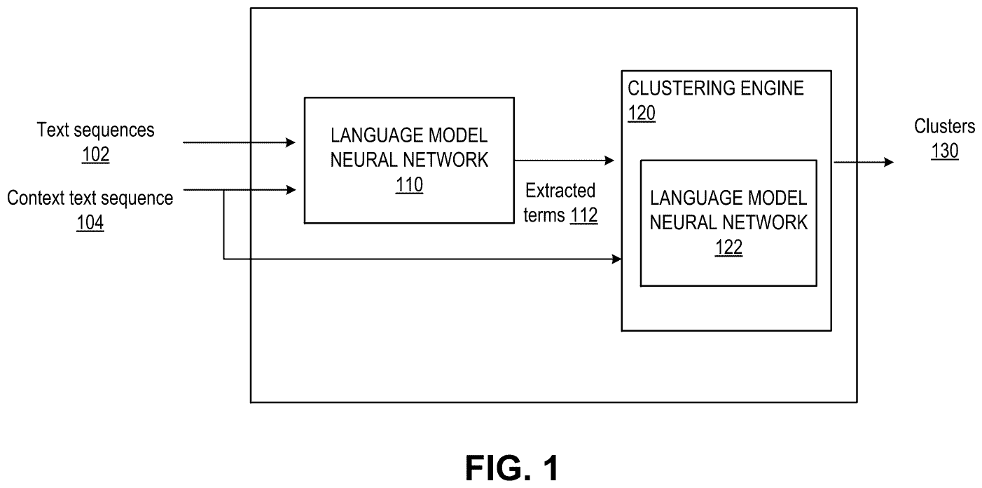

FIG. 1 is a block diagram of an example clustering system 100. The system 100 is an example of a system implemented as computer programs on one or more computers in one or more locations in which the systems, components, and techniques described below are implemented.

The clustering system 100 obtains text sequences 102 to be clustered. The clustering system 100 also obtains a context text sequence 104 that specifies a context for the clustering. The context for the clustering indicates the topic or subject for the clusters. For example, each cluster includes terms for a particular feature or particular category of the context. Each term can include one or more text symbols such as characters, numbers, or both.

Each particular cluster includes one or more terms that have the same meaning according to the context. For example, each term in a particular cluster is semantically equivalent to each other term in the particular cluster for the particular feature or category, and semantically different from terms in other clusters for other features or categories.

As an example, the context text sequence 104 can specify an aspect of a laboratory procedure such as a needle gauge. In this example, the system 100 clusters terms according to the value of needle gauge. For example, each particular cluster includes terms for the same value of needle gauge, and different clusters each include terms for a different value of needle gauge.

As another example, the context text sequence 104 can specify a patient affliction. In this example, the system 100 clusters terms according to the type of patient affliction. For example, each particular cluster includes terms for the same type of patient affliction, and different clusters each include terms for a different type of patient affliction.

The text sequences 102 include text sequences to be clustered. Each text sequence includes natural language text. In some examples, the text sequences 102 include text for a specific domain, such as text with noisy numerical values, or survey answers. As particular examples, one or more of the text sequences 102 can describe a laboratory procedure or include a medical patient's comments. As another example, one or more of the text sequences 102 can include at least a subset of text that describes a laboratory procedure or a subset of text that includes a medical patient's comments.

In some examples, the system 100 receives the text sequences 102 from a user, e.g., through a user interface of a user device. In some examples, the system 100 generates the text sequences 102 from input data that represents text. For example, the system 100 can receive input data that includes documents representing text and images. The system 100 can generate a text sequence for each document that includes the text represented by the document.

The context text sequence 104 includes natural language text that specifies a context for the clustering to be performed by the system 100. In some examples, the system 100 receives the context text sequence 104 from a user.

In some examples, the system 100 obtains the context text sequence 104 by processing one or more of the text sequences 102. For example, the system 100 can provide one or more of the text sequences 102 as input to a language model neural network such as the language model neural network 110 described below to generate the context text sequence. The system 100 can also include an instruction to identify the subject of the one or more text sequences in the input to the language model neural network. For example, the instruction can include “Please identify what all terms in {text sequence} refer to.” As an example, the text sequence can include a list of needle gauges. The context text sequence generated by the language model neural network can include “needle gauge.” As another example, the instruction can include “Please identify what all terms in {text sequences} refer to.” As an example, each text sequence can include one or more needle gauges. The context text sequence generated by the language model neural network can include “needle gauge.”

For each text sequence of the text sequences 102, the system 100 processes the text sequence and the context text sequence 104 using a language model neural network 110 to generate a respective extracted term of the extracted terms 112. Each extracted term describes content from the text sequence that is relevant to the context specified by the context text sequence 104.

In some examples, the extracted term includes a subset of the text included in the text sequence. That is, the extracted term describes content from the text sequence that is relevant to the context with text from the text sequence that is relevant to the context. For example, if the text sequence includes “My body is freezing,” the extracted term can include “body is freezing.”

In some examples, the extracted term includes text that is not directly included in the text sequence. That is, the extracted term describes content from the text sequence that is relevant to the context with text that is a rewording or summary of the content from the text sequence that is relevant to the context. As an example, if the text sequence includes “My body is freezing,” the extracted term can include “feeling cold.” In some examples, the extracted term can include text that is more directly relevant to the context than the text included in the text sequence. Thus the system 100 can generate extracted terms in a flexible manner that are relevant to the context for clustering.

For example, for each text sequence, the system 100 can provide a prompt that includes the text sequence and the context text sequence 104 as input to the language model neural network 110. The prompt can include an instruction to extract information from the text sequence that is relevant to the context text sequence 104.

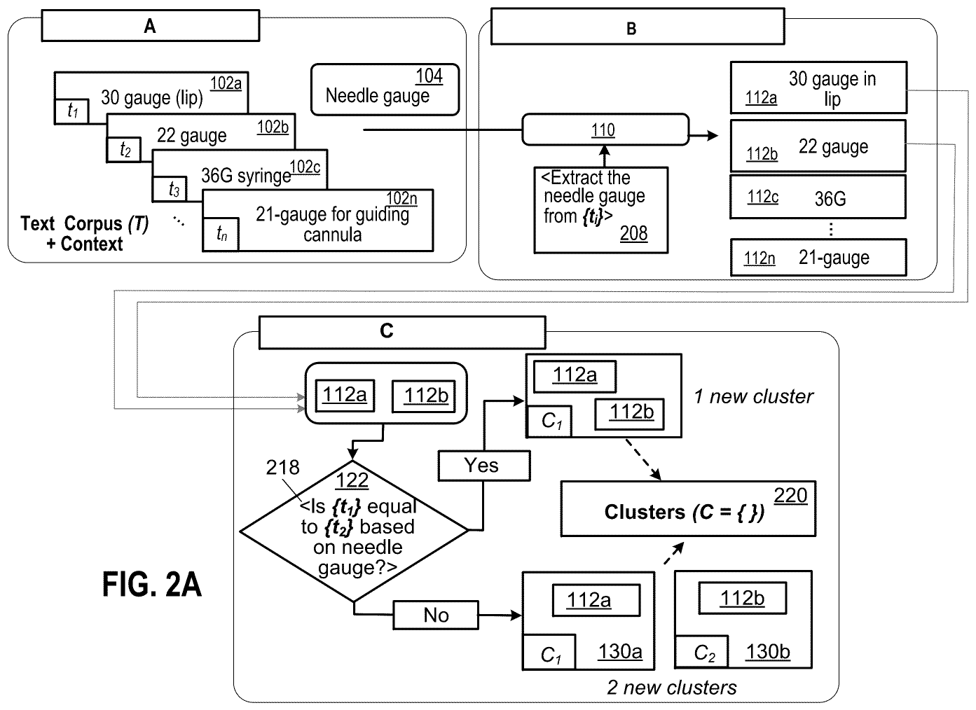

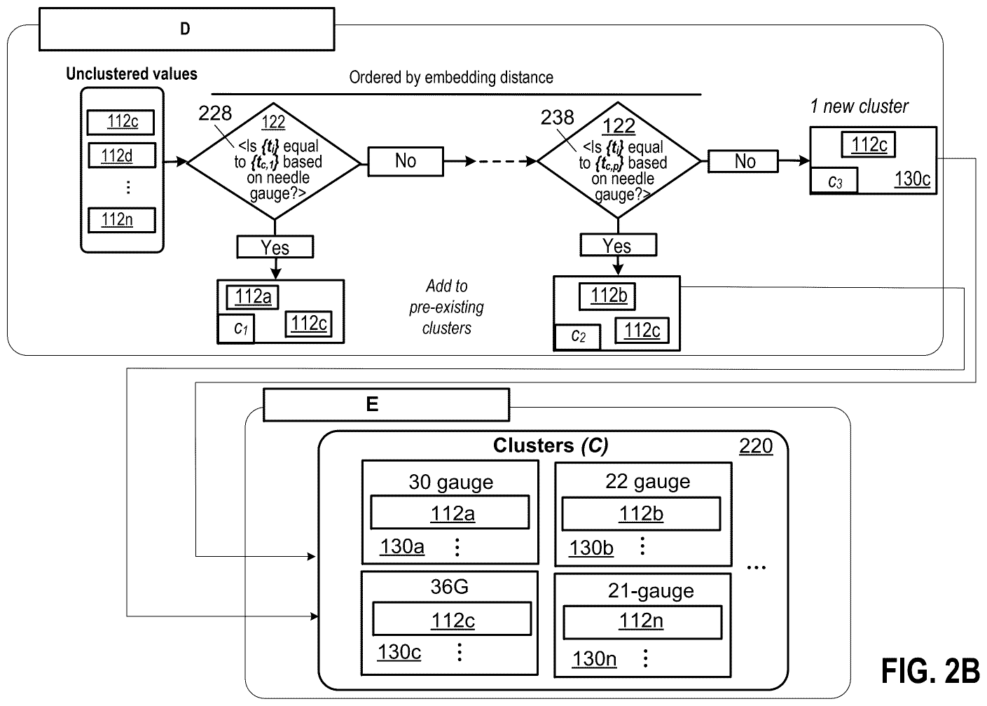

For example, system 100 can generate the prompt that includes an instruction, a text sequence, and a context text sequence in the format of “Extract the {context text sequence} from {text sequence}.” As a particular example, the prompt can include “Extract the {patient affliction} from {“My hair is falling out in huge amount.”}.” In this example, “patient affliction” is the context text sequence 104, and “My hair is falling out in huge amount.” is the text sequence. Other example prompts are described below with reference to FIG. 2A.

The system 100 can use any appropriate language model neural network. For example, the language model neural network 110 can be configured to perform a text processing task such as a language modeling task. For example, the language model neural network 110 does not need to have been specifically trained to perform a clustering task.

The language model neural network 110 can have any appropriate model architecture for performing a language modeling task. For example, the language model neural network 110 can be trained to predict, given an input sequence of tokens, the next token that follows the input sequence. The input sequence can include any previously predicted tokens and tokens representing the prompt.

For example, the language model neural network 110 can have a Transformer-based neural network architecture, such as an encoder-only Transformer architecture, an encoder-decoder Transformer architecture, a decoder-only Transformer architecture, or other attention-based architectures. Example language model neural networks include GPT-3 (Brown, T., et al., Language Models are Few-Shot Learners, arXiv:2005.14165, 2020), GPT-3.5, GPT-4, GPT-4o, Llama 3 (Llama Team, The Llama 3 Herd of Models, arXiv:2407.21783, 2024), and Claude 3 Opus.

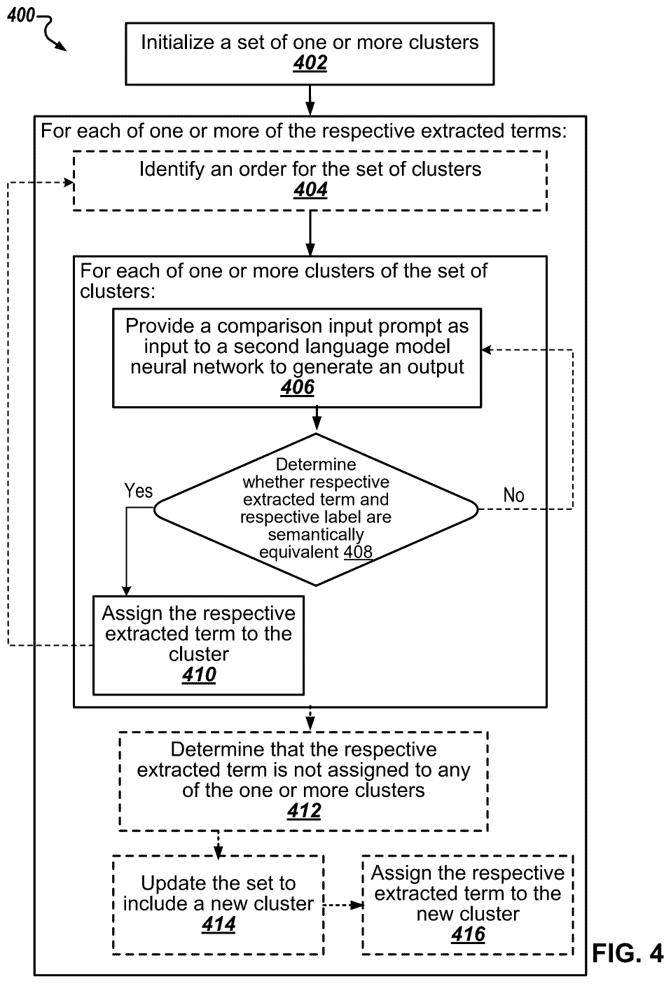

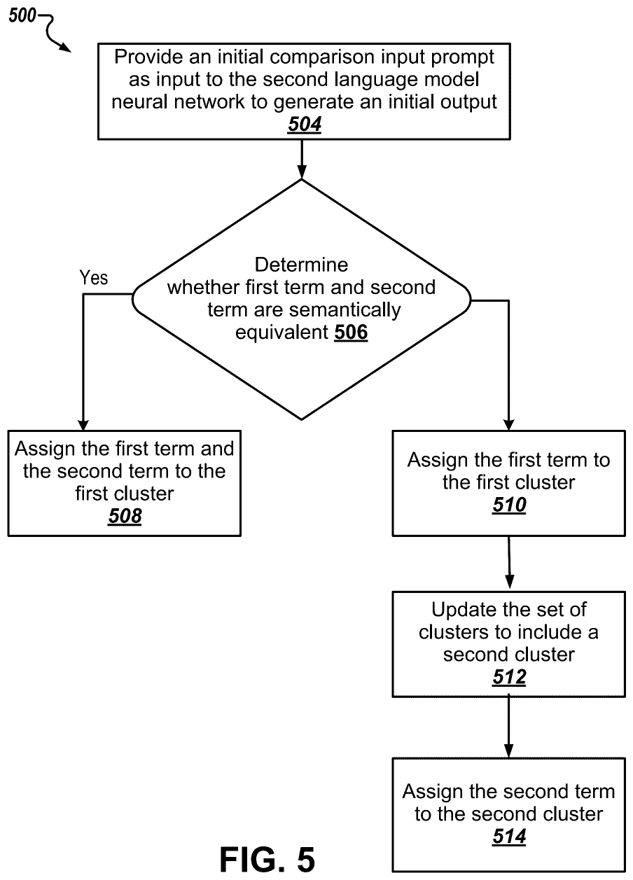

The system 100 can cluster the extracted terms 112 into clusters 130 using a clustering engine 120. The clustering engine 120 is configured to receive extracted terms 112 and cluster the extracted terms 112. For example, the clustering engine 120 can process each of the extracted terms 112 using a language model neural network 122 to assign each of the extracted terms 112 to a cluster in the clusters 130. Clustering the extracted terms 112 is described in further detail below with reference to FIGS. 4-5.

In some examples, the language model neural network 122 can be the same neural network as the language model neural network 110 described above. In some examples, the language model neural network 122 can be a different neural network from the language model neural network 110. For example, the language model neural network 122 can have a different model architecture and different model weights than the language model neural network 110. As a particular example, the language model neural network 122 can be a smaller language model neural network than the language model neural network 110, e.g., includes a smaller number of parameters than the language model neural network 110.

In some implementations, the system 100 can cluster the text sequences 102 using the clusters 130. For example, for each extracted term in each cluster, the system 100 can associate the text sequence for which the extracted term was generated with the cluster. The system 100 can thus cluster the text sequences 102 based on the context specified by the context text sequence 104.

In some examples, the system 100 can process the text sequences 102 based on the clusters 130 to identify text sequences that include a search term or that include one or more terms that are semantically equivalent to a search term. For example, the system 100 can use the clusters 130 to perform information retrieval from the text sequences 102. An information retrieval system of the system 100 or another information retrieval system can receive a request from a user to identify documents that mention a search term such as “30 gauge needle.” The information retrieval system can identify the cluster with a label that is the most similar to “30 gauge needle,” e.g., in an embedding space, out of the clusters. The information retrieval system can identify text sequences in the identified cluster that include “30 gauge needle.” The information retrieval system can provide data representing each of the identified text sequences in response to the request. Thus the system 100 can use the clusters 130 to efficiently identify text sequences that mention a search term without having to compare the search term to each of the extracted terms or text sequences 102.

As another example, the information retrieval system can receive a request from a user to identify documents that include one or more terms that are semantically equivalent to a search term such as “30 gauge needle.” The information retrieval system can identify the cluster with a label that is the most similar to “30 gauge needle,” e.g., in an embedding space, out of the clusters. The information retrieval system can provide data representing each of the text sequences of the identified cluster in response to the request. Thus the system 100 can use the clusters 130 to efficiently identify text sequences that include one or more terms that are semantically equivalent to a search term without having to receive the one or more terms that are semantically equivalent as input, or without having to compare the search term to each of the extracted terms or text sequences 102.

As another example, the system 100 can provide for filtering of the text sequences 102. For example, the system 100 can provide a user interface element for each cluster of the clusters 230 for presentation in a user interface. Each user interface element includes a description that describes the particular feature or particular category of the context for the cluster. The system 100 can receive an input from a user, e.g., through the user interface, that specifies a selected user interface element. In response to receiving the input from the user, the system 100 can provide data representing the text sequences for the cluster of the selected user interface element, i.e., the text sequences that include extracted terms that are semantically equivalent to the description of the selected user interface element.

The system 100 can derive the descriptions from the labels for the clusters 130. For example, the system 100 can use the label for each cluster as a description. The system 100 can thus reduce the number of user interface elements presented compared to presenting each extracted term, providing for a more efficient user experience and reducing the amount of computing resources required for displaying the user interface elements. As another example, the system 100 can generate a description in a standardized format for each label. For example, the label for a cluster can include “30 g.” The system 100 can generate a description, for example, using a language model neural network, that includes “30 gauge.” The system 100 can generate descriptions in the standardized format such as “30 gauge” or “31 gauge.” The system 100 can thus reduce the number of user interface elements presented compared to presenting each extracted term, and also provide for a more consistent user experience.

FIGS. 2A-2B show an example process 200 for clustering terms. For convenience, the process 200 will be described as being performed by a system of one or more computers located in one or more locations. For example, a clustering system, e.g., the clustering system 100 depicted in FIG. 1, appropriately programmed in accordance with this specification, can perform the process 200. In particular, FIGS. 2A-2B show an example process 200 for clustering terms that are needle gauges, extracted from text sequences describing experiments that involve needle gauges.

Referring to FIG. 2A, in step A, the system obtains multiple text sequences 102a-n as described above with reference to FIG. 1. For example, the text sequences 102a-n can each describe a laboratory procedure that involves needle gauges. In the example of FIG. 2A, each text sequence includes text from a preclinical animal trial for drug discovery. For example, text sequence 102a includes at least the text “30 gauge (lip),” text sequence 102b includes at least the text “22 gauge,” text sequence 102c includes at least the text “36 G syringe,” and text sequence 102n includes at least the text “21-gauge for guiding cannula.”

In step A, the system obtains the context text sequence 104 as described above with reference to FIG. 1. In the example of FIG. 2A, the context text sequence specifies an aspect of the experiment. For example, the context text sequence 104 includes the text “needle gauge” that specifies which needle gauge was used in the experiment.

In step B, the system generates extracted terms 112a-n from the text sequences 102a-n using the language model neural network 110. In the example of FIG. 2A, the language model neural network 110 generates the extracted term 112a “30 gauge in lip” from the text sequence 102a that includes at least “30 gauge (lip).” As another example, the language model neural network 110 generates the extracted term 112n “21-gauge” from the text sequence 102n that includes at least “21-gauge for guiding cannula.”

For example, for each text sequence, the system can provide a prompt 208 that includes the text sequence and the context text sequence 104 as input to the language model neural network 110. In the example of FIG. 2A, the prompt 208 also includes an instruction to extract information from the text sequence that is relevant to the context text sequence 104. For example, the prompt 208 includes the text “Extract the needle gauge from {tᵢ}” where tᵢ represents the i-th text sequence of the text sequences 102a-n. For example, the prompt 208 for the text sequence 102a can include “Extract the needle gauge from “21-gauge for guiding cannula”.”

In some examples, the prompt 208 can include one or more examples, also referred to as in-context prompt examples. Each in-context prompt example can include an example text sequence and one or more example extracted terms that describe content from the example text sequence that is relevant to the context. In some examples, the prompt 208 can also include an instruction to extract information from the text sequence that is relevant to the context according to the examples.

For example, the prompt 208 can include the text:
Needle gauge is a quantity measuring the gauge of a needle in a biopsy. You will be given a list of input data containing needle gauges. For each value, extract the needle gauge from the input data. For example, given the input: [5-gauge, 1.25 mm diameter, 21 gauge (human study), 10 G, 6 mm in length], you could extract the needle gauge for each value as follows:
5-gauge: 5 gauge
1.25 mm diameter: 1.25 mm
21 gauge (human study): 21 gauge

In examples where the context text sequence 104 specifies a patient affliction or disease, the prompt 208 can include the text:
You will be given a list of complaints from patients. Extract the disease from the following values. Please provide your answer in a format like: “cancer”. There is always a possible value to extract; however, if you believe there is none, please respond with “N/A”. For example, given the following value: “I used to be out of breath after going up a dozen of stairs, but now I struggle to breath even when I sit down.”, you could extract the disease as follows: “hard to breathe”
Another example is “My head hurts whenever I try to do something.” where the answer would be “headache”
Another example is “When I'm driving my eyes see in double” where the answer would be “blurry vision”

In some examples, the instruction can specify a level of granularity for the clustering, e.g., through a description or according to one or more examples. For example, different levels of granularity for a patient affliction can include different levels of detail of the same disease type, such as “skin issue” and “acne.”

In some examples, the system 100 can obtain at least part of the prompt 208 from a user. For example, as described above with reference to FIG. 1, the system 100 can generate the prompt 208 to include an instruction in a particular format. In some examples, the system 100 can receive an input from the user that specifies the instruction. In some examples, the system 100 can also receive an input from the user that specifies one or more examples. In some examples, the system 100 can also receive an input from the user that includes an instruction to extract information from the text sequence that is relevant to the context according to the examples.

In some examples, the prompt 208 can include an instruction to perform chain-of-thought prompting. For example, the instruction can include “Extract the needle gauge from {input text sequence}. Double check your answer to make sure that your output is indeed an example of a needle gauge.”

In some examples, for each text sequence, the system can provide multiple prompts as input to the language model neural network 110. For example, the system can provide the prompt 208 as input to the language model neural network 110 to generate an extracted term. The system 100 can provide an additional prompt as input to the language model neural network 110 that includes the generated extracted term and an instruction to determine whether the generated extracted term is an appropriate feature value or category for the context. For example, the additional prompt can include “Is {extracted term} an example of {context text sequence}?” In the example of FIG. 2A, the additional prompt can include “Is 21 gauge an example of needle gauge?”

The output from the language model neural network can specify whether the generated extracted term is an appropriate feature value or category for the context. In some examples, in response to determining that the output specifies that the generated extracted term is not an appropriate feature value or category for the context, the system can repeat the steps of providing the prompt 208 as input to the language model neural network 110, and providing the additional prompt for the generated extracted term as input to the language model neural network, until the system determines that the output specifies that the generated extracted term is an appropriate feature value or category for the context. In some examples, in response to determining that the output specifies that the generated extracted term is not an appropriate feature value or category for the context, the system can repeat the steps using an updated prompt. The updated prompt can have a different instruction than the prompt 208, for example. The system can repeat the steps for a threshold number of iterations, for example. In some examples, in response to determining that the output specifies that the generated extracted term is not an appropriate feature value or category for the context, the system can refrain from processing the text sequence through any further steps C-E. In some examples, the system can update the text sequences 102a-n to not include the text sequence.

In step C, the system initializes a set of clusters C 220 to include at least a first cluster.

To initialize the set of clusters, the system obtains two extracted terms from the extracted terms 112a-n. For example, the system can randomly select the two extracted terms. In the example of FIG. 2A, the first extracted term is the extracted term 112a and the second extracted term is the extracted term 112b. The system determines whether the extracted term 112a and the extracted term 112b are semantically equivalent given the context text sequence 104. For example, the system can provide an initial comparison input prompt 218 to the language model neural network 122 to generate an output specifying whether the first term and the second term are semantically equivalent.

In the example of FIG. 2A, the initial comparison input prompt includes “Is “30 gauge in lip” equal to “22 gauge” based on needle gauge?” The language model neural network 122 generates an output (“No”) that specifies that the extracted term 112a and the extracted term 112b are not semantically equivalent. Thus the system initializes the set of clusters C 220 to include two clusters, cluster c₁ 130a and cluster c₂ 130b.

Each cluster can be identified by a label. In some examples, the label includes the text of the first extracted term to be added to the cluster. For example, the label of cluster c₁ 130a includes the text of extracted term 112a, “30 gauge in lip.” The label of cluster c₂ 130b includes the text of extracted term 112b, “22 gauge.”

In some examples, the label includes text derived from the terms of the cluster. For example, the system can generate the label for the cluster by providing the terms of the cluster as input to the language model neural network 122. For example, the system can also provide an instruction to generate a label for the provided terms. As a particular example, the terms of the cluster can include “21 gauge needle (human study)”, “21 g needle”, “21 gauge needle syringe”, “21 G”, “21 G”. The system can provide the input “Create a succinct label for this cluster of terms: “21 gauge needle (human study)”, “21 g needle”, “21 gauge needle syringe”, “21 G”, “21 G”]” to the language model neural network 122 to generate the label for the cluster.

Referring to FIG. 2B, in step D, the system clusters the remaining extracted terms 112c-n. For example, the system compares each of the remaining extracted terms 112c-n with the labels of one or more clusters in the set of clusters C 220. For example, for each remaining extracted term, and for one or more of the clusters in the clusters C 220, the system can provide a comparison input prompt to the language model neural network 122 to generate an output specifying whether the extracted term and the label for the cluster are semantically equivalent. Assigning extracted terms is described in more detail below with reference to FIG. 4.

In the example of FIG. 2B, the comparison input prompt 228 for the extracted term 112c and the cluster c₁ 130a includes “Is “36 G” equal to “30 gauge in lip” based on needle gauge?” The language model neural network 122 generates an output (“No”) that specifies that the extracted term 112c is not semantically equivalent with the label of the cluster 130a, which is the extracted term 112a. Because the extracted term 112c is not semantically equivalent with the label of the cluster 130a, the system does not assign the extracted term 112c to the cluster c₁ 130a. The system proceeds to compare the extracted term 112c with another cluster in the clusters C 220.

For example, the comparison input prompt 238 for the extracted term 112c and the cluster c₂ 130b includes “Is “36 G” equal to “22 gauge” based on needle gauge?” The language model neural network 122 generates an output (“No”) that specifies that the extracted term 112c is not semantically equivalent with the label of the cluster 130b, which is the extracted term 112b. Because the extracted term 112c is not semantically equivalent with the label of the cluster 130b, the system does not assign the extracted term 112c to the cluster c₂ 130b. The system proceeds to compare the extracted term 112c with another cluster in the clusters C 220.

In the example of FIG. 2B, there are no other clusters in the clusters C 220 with which to compare the extracted term 112c. Thus the system updates the set of clusters 220 to include a new cluster c₃ 130c. The system includes the extracted term 112c in the new cluster 130c.

In step E, after performing step D for each of the remaining extracted values 112c-n, the system outputs the set of clusters C 220. For example, the system can output data representing the set of clusters C 220. As another example, the system can output data representing cluster assignments for the extracted terms 112 or the text sequences 102.

In the example of FIG. 2B, the clusters 220 include clusters 130a-n. For example, the clusters 220 include the cluster 130a with the label “30 gauge.” The cluster 130a includes the extracted term 112a and any other extracted terms that are semantically equivalent to “30 gauge.” As an example, if extracted term 112d includes “30 gauge hamilton syringe,” the cluster 130a can also include the extracted term 112d.

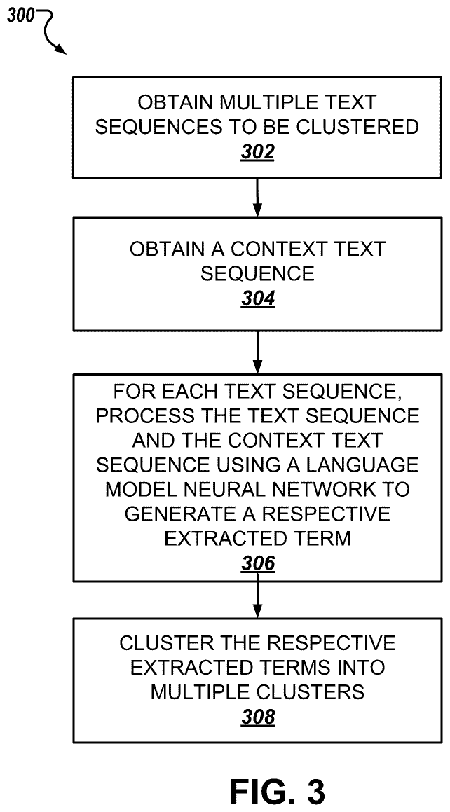

FIG. 3 is a flow diagram of an example process 300 for clustering terms. For convenience, the process 300 will be described as being performed by a system of one or more computers located in one or more locations. For example, a clustering system, e.g., the clustering system 100 of FIG. 1, appropriately programmed in accordance with this specification, can perform the process 300.

The system obtains multiple text sequences to be clustered (step 302). In some examples, the system can receive the multiple text sequences from a user.

The system obtains a context text sequence (step 304). The context text sequence specifies a context for the clustering. In some examples, the system can receive the context text sequence from the user.

For each text sequence, the system processes the text sequence and the context text sequence using a language model neural network to generate a respective extracted term (step 306). For example, the system can provide a prompt that includes the text sequence and the context text sequence as input to the language model neural network to generate the respective extracted term. In some examples, the prompt can include an instruction to extract information from the text sequence that is relevant to the context text sequence. Example prompts are described above with reference to FIG. 2A.

In some examples, for each text sequence, the system can generate multiple respective extracted terms. For example, the system can provide a prompt that includes the text sequence and the context text sequence as input to the language model neural network to generate the respective extracted terms. In some examples, the prompt can include an instruction to extract all instances of information from the text sequence that are relevant to the context text sequence.

In some examples, the system generates the prompt according to a default format for the instruction, context text sequence, and text sequence, such as “Extract the {context text sequence} from {text sequence}.”

In some examples, the system obtains a format for the prompt from a user, e.g., through a user interface of the system. For example, the system can receive an input from the user that specifies the format for the prompt. As an example, the input can include “Extract the {context text sequence} from the following {text sequence}. Please provide your answer in a format like: “cancer”.”

In some examples, the system can receive an input from the user that specifies a modification to an existing format for the prompt. For example, the system can provide data representing the existing format for the prompt, e.g., a default format or a previously received format from the user, for display to the user. The system can receive an input from the user that represents one or more edits to the existing format for the prompt. The system can modify the existing format for the prompt to incorporate the one or more edits received from the user.

Each respective extracted term describes content from the text sequence that is relevant to the context. Each respective extracted term can include, for example, a subset of the text sequence that is relevant to the context, or a summary of content from the text sequence that is relevant to the context.

The system clusters the respective extracted terms into multiple clusters (step 308). For example, the system can initialize the set to include one or more clusters. For each of one or more of the respective extracted terms, the system can process each of one or more clusters of the set of clusters. In some examples, the system can process each of one or more clusters of the set of clusters according to an order for the set of clusters. Clustering the respective extracted terms into multiple clusters is described in further detail below with reference to FIGS. 4-5.

In some examples, one or more of the text sequences describes a laboratory procedure, and the context text sequence specifies an aspect of the laboratory procedure. For example, the aspect can include a needle gauge, a type of organism involved in the laboratory procedure, properties of a drug administered in the laboratory procedure, or other experimental methods of the laboratory procedure.

In some examples, one or more of the text sequences describes a patient comment, and the context text sequence specifies the type of disease or the patient affliction of the patient comment.

FIG. 4 is a flow diagram of an example process 400 for assigning terms to clusters. For convenience, the process 400 will be described as being performed by a system of one or more computers located in one or more locations. For example, a clustering system, e.g., the clustering system 100 of FIG. 1, appropriately programmed in accordance with this specification, can perform the process 400.

The process 400 can be used to cluster any appropriate terms. For example, the process 400 can be used to cluster extracted terms generated using a language model neural network as described above with reference to step 306 of FIG. 3.

The system initializes a set of one or more clusters (step 402). The system can initialize the set to include at least a first cluster. Initializing the set of clusters is described in further detail below with reference to FIG. 5.

The system performs steps 404-414 for each of one or more of the respective extracted terms. For example, the system performs steps 404-414 for each of the respective extracted terms that were not already assigned to clusters in step 402.

The system identifies an order for the set of clusters (step 404). For example, the order can be based on embedding similarity scores for the labels of the clusters in the set of clusters.

For example, the system can generate, for each cluster in the set of clusters, an embedding similarity score for the respective label for the cluster and the respective extracted term. The embedding similarity score represents a measure of similarity between the respective label and the respective extracted term.

In some examples, to generate the embedding similarity score, the system can generate an extracted term embedding for the respective extracted term. For example, the system can provide the respective extracted term as input to an embedding model.

The embedding model can be configured to generate embeddings of text data. An “embedding,” as used in this specification is a vector of numeric values, e.g., floating point or other type of numeric values, that has a predetermined dimensionality, e.g., has a predetermined number of values. Example embedding models include word2vec or Bidirectional Encoder Representations from Transformers (BERT), described in Devlin, J., et al, BERT: Pre-training of Deep Bidirectional Transformers for Language Understanding, arXiv:1810.04805, 2019.

The system can generate the embedding similarity score for the respective label for each cluster and the respective extracted term based on a distance between an embedding for the respective label and the extracted term embedding. In some examples, the system can obtain the embedding for the respective label using the embedding model.

As a particular example, the embedding similarity score can be based on the cosine distance between the embedding for the respective label and the extracted term embedding. For example, a lower cosine distance can indicate a greater similarity between the respective label and the respective extracted term. In some examples, a lower embedding similarity score can indicate a lower cosine distance. In some other examples, a higher embedding similarity score can indicate a lower cosine distance.

The system can order the clusters in the set of clusters based on the embedding similarity scores, i.e., so that clusters with more similar labels to the respective extracted term are earlier in the order than clusters with less similar labels according to the similarity scores. In examples where lower embedding similarity scores indicate a greater similarity, the system can order the clusters in order of ascending embedding similarity scores. In examples where higher embedding similarity scores indicate a greater similarity, the system can order the clusters in order of descending embedding similarity scores.

The system processes each of one or more clusters of the set of clusters by performing steps 406-410. For example, the system performs steps 406-410 for one or more clusters of the set of clusters until the system performs step 410 for a particular cluster.

The system can process each of one or more clusters according to the order for the set of clusters for the respective extracted term identified in step 404. By processing the clusters according to the order, the system can compare the respective extracted term with labels of clusters that are more similar to the respective extracted term, increasing the likelihood that that the respective extracted term is assigned to a cluster earlier in the order. The system thus decreases the likelihood that the system will need to compare the respective extracted term with labels of all of the clusters, and in some examples, decreases the number of calls to the second language model neural network.

The system provides a comparison input prompt as input to a second language model neural network to generate an output (step 406). In some examples, the second language model neural network is the same neural network as the language model neural network.

The comparison input prompt includes i) the respective extracted term, ii) a respective label for the cluster, and iii) the context text sequence. The respective label for the cluster includes the first respective extracted term assigned to the cluster. The comparison input prompt can also include an instruction to determine whether the respective extracted term and the respective label are semantically equivalent given the context specified by the context sequence. For example, the comparison input prompt can include “Is {extracted term} equal to {label} based on {context text sequence}?.” As another example, the comparison input prompt can include “Is {extracted term} equivalent to {label} considering the context {context text sequence}?.”

In some examples, the system generates the comparison input prompt according to a default format, such as “Is {extracted term} equal to {label} based on {context text sequence}?.”

In some examples, the system obtains a format for the comparison input prompt from a user, e.g., through a user interface of the system. For example, the system can receive an input from the user that specifies the format for the comparison input prompt. As an example, the input can include “Is {extracted term} equivalent to {label} considering the context {context text sequence}?.”

In some examples, the system can receive an input from the user that specifies a modification to an existing format for the comparison input prompt. For example, the system can provide data representing the existing format for the comparison input prompt, e.g., a default format or a previously received format from the user, for display to the user. The system can receive an input from the user that represents one or more edits to the existing format for the comparison input prompt. The system can modify the existing format for the comparison input prompt to incorporate the one or more edits received from the user.

The output specifies whether the respective extracted term and the respective label are semantically equivalent given the context sequence. For example, the output can include the text “true” or “false.”

The system determines whether the respective extracted term and the respective label are semantically equivalent (step 408). For example, the system can determine that the respective extracted term and the respective label are semantically equivalent if the output includes “true.” The system can determine that the respective extracted term and the respective label are not semantically equivalent if the output includes “false.”

If the system determines that the respective extracted term and the respective label are semantically equivalent, the system assigns the respective extracted term to the cluster (step 410). In some examples, the system then proceeds to perform step 404 for another respective extracted term that has not been assigned to a cluster. By proceeding to perform step 404 for another respective extracted term after assigning the respective extracted term, the system does not need to compare the respective extracted term with labels for all clusters, decreasing the number of calls to the second language model neural network.

If the system determines that the respective extracted term and the respective label are not semantically equivalent, the system proceeds to perform step 406 for another cluster of the set of clusters. For example, the system can proceed to perform step 406 for the next cluster in the order.

In some examples, the system determines that the respective extracted term is not assigned to any of the one or more clusters (step 412). For example, the system can determine that the respective extracted term is not assigned to any of the clusters if the system has performed steps 406-408 for the respective extracted term for all of the clusters in the set of clusters, and the system has not performed step 410. In response, the system updates the set to include a new cluster (step 414). The system assigns the respective extracted term to the new cluster (step 416). The system then proceeds to perform step 404 for another respective extracted term that has not been assigned to a cluster.

FIG. 5 is a flow diagram of an example process 500 for initializing a set of clusters. For convenience, the process 500 will be described as being performed by a system of one or more computers located in one or more locations. For example, a clustering system, e.g., the clustering system 100 of FIG. 1, appropriately programmed in accordance with this specification, can perform the process 500.

The system can perform the process 500 as part of step 402 described above with reference to FIG. 4.

The system provides an initial comparison input prompt as input to the second language model neural network to generate an initial output (step 504). The initial comparison input prompt includes i) a first term of the respective extracted terms, ii) a second term of the respective extracted terms, and iii) the context text sequence. In some examples, the system can randomly select the first term from the respective extracted terms.

The initial comparison input prompt can also include an instruction to determine whether the first term and the second term are semantically equivalent given the context specified by the context sequence. For example, the initial comparison input prompt can include “Is {first term} equal to {second term} based on {context text sequence}?.” As another example, the initial comparison input prompt can include “Is {first term} equivalent to {second term} considering the context {context text sequence}?.”

In some examples, the system generates the initial comparison input prompt according to a default format for the instruction, such as “Is {first term} equal to {second term} based on {context text sequence}?.”

In some examples, the system obtains a format for the initial comparison input prompt from a user, e.g., through a user interface of the system. For example, the system can receive an input from the user that specifies the format for the initial comparison input prompt. As an example, the input can include “Is {first term} equal to {second term} based on {context text sequence}?.”

In some examples, the system can receive an input from the user that specifies a modification to an existing format for the initial comparison input prompt. For example, the system can provide data representing the existing format for the initial comparison input prompt, e.g., a default format or a previously received format from the user, for display to the user. The system can receive an input from the user that represents one or more edits to the existing format for the initial comparison input prompt. The system can modify the existing format for the initial comparison input prompt to incorporate the one or more edits received from the user.

The initial output specifies whether the first term and the second term are semantically equivalent given the context sequence. For example, the output can include the text “true” or “false.”

The system determines whether the first term and the second term are semantically equivalent (step 506). For example, the system can determine that the first term and the second term are semantically equivalent if the initial output includes “true.” The system can determine that the first term and the second term are not semantically equivalent if the initial output includes “false.”

If the system determines that the first term and the second term are semantically equivalent, the system assigns the first term and the second term to the first cluster (step 508). In these examples, the set of clusters is initialized to include one cluster.

If the system determines that the first term and the second term are not semantically equivalent, the system assigns the first term to the first cluster (step 510). The system updates the set of clusters to include a second cluster (step 512). The system assigns the second term to the second cluster (step 514). In these examples, the set of clusters is initialized to include two clusters.

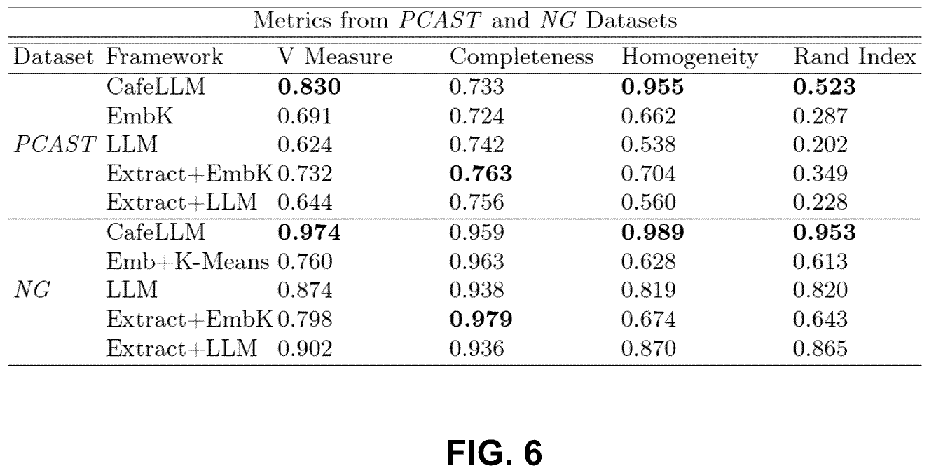

FIG. 6 shows the performance of an example clustering system. For example, FIG. 6 shows a comparison between the V Measure, Completeness, Homogeneity, and Rand Index of variants of a CafeLLM system (corresponding to the clustering system described in this specification) and several other systems. The variants include a system that includes the extraction step described above with reference to FIG. 3 and a single LLM prompt to generate the clusters (“Extract+LLM”) and a system that includes the extraction step described above with reference to FIG. 3, and clustering embeddings of the terms using a pre-trained embedder and K-means clustering (“Extract+EmbK”).

The other systems include an LLM prompting system (“LLM”), and an embedding and K-means system (“EmbK”). The “LLM” system clusters terms using a single prompt to a language model neural network. The “EmbK” system clusters embeddings of sequences of text using a pre-trained embedding and K-means clustering.

FIG. 6 shows that the CafeLLM system outperforms or is competitive for the LLM and EmbK systems across all measures, for the patient comment dataset (“PCAST”) and the needle gauge dataset (“NG”).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative.

Embodiment 1 is a computer-implemented method comprising: obtaining a plurality of text sequences to be clustered; obtaining a context text sequence specifying a context for the clustering; for each text sequence of the plurality of text sequences, processing the text sequence and the context text sequence using a language model neural network to generate a respective extracted term that describes content from the text sequence that is relevant to the context; and clustering the respective extracted terms for the text sequences into a plurality of clusters.

Embodiment 2 is the method of embodiment 1, further comprising: for each cluster, and for each respective extracted term in the cluster, associating with the cluster the text sequence for which the respective extracted term was generated.

Embodiment 3 is the method of any of embodiments 1-2, wherein obtaining the context text sequence comprises receiving the context text sequence from a user.

Embodiment 4 is the method of any of embodiments 1-3, wherein obtaining a plurality of text sequences to be clustered comprises receiving the plurality of text sequences from a user.

Embodiment 5 is the method of any of embodiments 1-4, wherein processing the text sequence and the context text sequence using a language model neural network to generate a respective extracted term comprises providing a prompt comprising the text sequence and the context text sequence as input to the language model neural network.

Embodiment 6 is the method of embodiment 5, wherein the prompt further comprises an instruction to extract information from the text sequence that is relevant to the context text sequence.

Embodiment 7 is the method of any of embodiments 5-6, wherein the prompt further comprises one or more examples, wherein each example comprises an example text sequence and one or more example extracted terms that describe content from the example text sequence that is relevant to the context, and wherein the prompt further comprises an instruction to extract information from the text sequence that is relevant to the context according to the examples.

Embodiment 8 is the method of any of embodiments 1-7, wherein clustering the respective extracted terms for the text sequences into a plurality of clusters comprises: initializing a set of one or more clusters to include at least a first cluster; and for each of one or more of the respective extracted terms: processing each of one or more clusters of the set of clusters, comprising: providing a comparison input prompt comprising i) the respective extracted term, ii) a respective label for the cluster, and iii) the context text sequence as input to a second language model neural network to generate an output specifying whether the respective extracted term and the respective label are semantically equivalent given the context sequence; determining whether the respective extracted term and the respective label are semantically equivalent based on the output; and in response to determining that the respective extracted term and the respective label are semantically equivalent, assigning the respective extracted term to the cluster.

Embodiment 9 is the method of embodiment 8, wherein the respective label for the cluster comprises a first respective extracted term assigned to the cluster.

Embodiment 10 is the method of any of embodiments 8-9, wherein initializing a set of one or more clusters to include at least a first cluster comprises: providing an initial comparison input prompt comprising i) a first term of the respective extracted terms, ii) a second term of the respective extracted terms, and iii) the context text sequence as input to the second language model neural network to generate an initial output specifying whether the first term and the second term are semantically equivalent given the context sequence; determining whether the first term and the second term are semantically equivalent based on the initial output; and in response to determining that the first term and the second term are semantically equivalent, assigning the first term and the second term to the first cluster.

Embodiment 11 is the method of embodiment 10, further comprising, in response to determining that the first term and the second term are not semantically equivalent: assigning the first term to the first cluster; updating the set of clusters to include a second cluster; and assigning the second term to the second cluster.

Embodiment 12 is the method of any of embodiments 8-11, wherein processing each of one or more of clusters of the set of clusters comprises processing each of the one or more clusters according to an order for the set of clusters, and wherein the method further comprises, for each of one or more of the respective extracted terms, identifying the order for the set of clusters for the respective extracted term.

Embodiment 13 is the method of embodiment 12, wherein identifying the order for the set of clusters for the respective extracted term comprises: generating, for each cluster in the set of clusters, an embedding similarity score for the respective label for the cluster and the respective extracted term; and ordering the clusters in the set of clusters based on the embedding similarity scores.

Embodiment 14 is the method of embodiment 13, wherein generating, for each cluster in the set of clusters, an embedding similarity score for the respective label for the cluster and the respective extracted term comprises: generating an extracted term embedding for the respective extracted term; and generating, for each cluster, the embedding similarity score based on a distance between an embedding for the respective label and the extracted term embedding.

Embodiment 15 is the method of any of embodiments 8-14, further comprising, for each of one or more of the respective extracted terms: determining that the respective extracted term is not assigned to any of the one or more clusters; in response, updating the set to include a new cluster; and assigning the respective extracted term to the new cluster.

Embodiment 16 is the method of any of embodiments 1-15, wherein one or more of the text sequences describes a laboratory procedure, and wherein the context text sequence specifies an aspect of the laboratory procedure.

Embodiment 17 is a system comprising one or more computers and one or more storage devices storing instructions that when executed by the one or more computers cause the one or more computers to perform the method of any of embodiments 1-16.

Embodiment 18 is one or more non-transitory computer-readable storage media storing instructions that when executed by one or more computers cause the one more computers to perform the method of any of embodiments 1-16.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a plurality of text sequences to be clustered;
obtaining a context text sequence specifying a context for the clustering;
for each text sequence of the plurality of text sequences, processing the text sequence and the context text sequence using a language model neural network to generate a respective extracted term that describes content from the text sequence that is relevant to the context; and
clustering the respective extracted terms for the text sequences into a plurality of clusters.

2. The method of claim 1, further comprising:
for each cluster, and for each respective extracted term in the cluster, associating with the cluster the text sequence for which the respective extracted term was generated.

3. The method of claim 1, wherein obtaining the context text sequence comprises receiving the context text sequence from a user.

4. The method of claim 1, wherein obtaining a plurality of text sequences to be clustered comprises receiving the plurality of text sequences from a user.

5. The method of claim 1, wherein processing the text sequence and the context text sequence using a language model neural network to generate a respective extracted term comprises providing a prompt comprising the text sequence and the context text sequence as input to the language model neural network.

6. The method of claim 5, wherein the prompt further comprises an instruction to extract information from the text sequence that is relevant to the context text sequence.

7. The method of claim 5, wherein the prompt further comprises one or more examples, wherein each example comprises an example text sequence and one or more example extracted terms that describe content from the example text sequence that is relevant to the context, and wherein the prompt further comprises an instruction to extract information from the text sequence that is relevant to the context according to the examples.

8. The method of claim 1, wherein clustering the respective extracted terms for the text sequences into a plurality of clusters comprises:
initializing a set of one or more clusters to include at least a first cluster; and
for each of one or more of the respective extracted terms:
processing each of one or more clusters of the set of clusters, comprising:
providing a comparison input prompt comprising i) the respective extracted term, ii) a respective label for the cluster, and iii) the context text sequence as input to a second language model neural network to generate an output specifying whether the respective extracted term and the respective label are semantically equivalent given the context sequence;
determining whether the respective extracted term and the respective label are semantically equivalent based on the output; and
in response to determining that the respective extracted term and the respective label are semantically equivalent, assigning the respective extracted term to the cluster.

9. The method of claim 8, wherein the respective label for the cluster comprises a first respective extracted term assigned to the cluster.

10. The method of claim 8, wherein initializing a set of one or more clusters to include at least a first cluster comprises:
providing an initial comparison input prompt comprising i) a first term of the respective extracted terms, ii) a second term of the respective extracted terms, and iii) the context text sequence as input to the second language model neural network to generate an initial output specifying whether the first term and the second term are semantically equivalent given the context sequence;
determining whether the first term and the second term are semantically equivalent based on the initial output; and
in response to determining that the first term and the second term are semantically equivalent, assigning the first term and the second term to the first cluster.

11. The method of claim 10, further comprising, in response to determining that the first term and the second term are not semantically equivalent:
assigning the first term to the first cluster;
updating the set of clusters to include a second cluster; and
assigning the second term to the second cluster.

12. The method of claim 8, wherein processing each of one or more of clusters of the set of clusters comprises processing each of the one or more clusters according to an order for the set of clusters, and wherein the method further comprises, for each of one or more of the respective extracted terms, identifying the order for the set of clusters for the respective extracted term.

13. The method of claim 12, wherein identifying the order for the set of clusters for the respective extracted term comprises:
generating, for each cluster in the set of clusters, an embedding similarity score for the respective label for the cluster and the respective extracted term; and
ordering the clusters in the set of clusters based on the embedding similarity scores.

14. The method of claim 13, wherein generating, for each cluster in the set of clusters, an embedding similarity score for the respective label for the cluster and the respective extracted term comprises:
generating an extracted term embedding for the respective extracted term; and
generating, for each cluster, the embedding similarity score based on a distance between an embedding for the respective label and the extracted term embedding.

15. The method of claim 8, further comprising, for each of one or more of the respective extracted terms:
determining that the respective extracted term is not assigned to any of the one or more clusters;
in response, updating the set to include a new cluster; and
assigning the respective extracted term to the new cluster.

16. The method of claim 1, wherein one or more of the text sequences describes a laboratory procedure, and wherein the context text sequence specifies an aspect of the laboratory procedure.

17. A system comprising one or more computers and one or more storage devices storing instructions that when executed by the one or more computers cause the one or more computers to perform operations comprising:
obtaining a plurality of text sequences to be clustered;
obtaining a context text sequence specifying a context for the clustering;
for each text sequence of the plurality of text sequences, processing the text sequence and the context text sequence using a language model neural network to generate a respective extracted term that describes content from the text sequence that is relevant to the context; and
clustering the respective extracted terms for the text sequences into a plurality of clusters.

18. The system of claim 17, further comprising:
for each cluster, and for each respective extracted term in the cluster, associating with the cluster the text sequence for which the respective extracted term was generated.

19. The system of claim 17, wherein processing the text sequence and the context text sequence using a language model neural network to generate a respective extracted term comprises providing a prompt comprising the text sequence and the context text sequence as input to the language model neural network.

20. One or more non-transitory computer-readable storage media storing instructions that when executed by one or more computers cause the one more computers to perform operations comprising:
obtaining a plurality of text sequences to be clustered;
obtaining a context text sequence specifying a context for the clustering;
for each text sequence of the plurality of text sequences, processing the text sequence and the context text sequence using a language model neural network to generate a respective extracted term that describes content from the text sequence that is relevant to the context; and
clustering the respective extracted terms for the text sequences into a plurality of clusters.
